(19) United States
(12) Patent Application Publication
(10) Pub. No.: US 2006/0065128 A1
(43) Pub. Date: Mar. 30, 2006

(54) Structure of brewing chamber of coffee machine

(75) Inventor: Kun-Mou Lu, Shulin City (TW)

Correspondence Address: GENUS LAW GROUP;LOWE HAUPTMAN & BERNER, LLP, 1700 DIAGONAL ROAD, SUITE 300, ALEXANDRIA, VA, 22314, US

(73) Assignee: DELOS VENDING MACHINE CO., LTD.

(21) Appl. No.: 11/233,579

(22) Filed: Sep. 22, 2005

(30) Foreign Application Priority Data
Sep. 29, 2004 (TW) 93129477

(51) Int. Cl. A47J 31/44

(52) U.S. Cl. 99/279

(57) ABSTRACT

An improved structure of brewing chamber of a coffee machine is disclosed by setting an intercepting device in an extracting pipe of a traditional brewing chamber of a coffee machine and two draining through-holes into the bottom of the traditional brewing chamber. Due to the intercepting device, the extracted coffee liquid coming from the brewing chamber can be drained off the extracting pipe with a stable speed and the coffee grain in the brewing chamber can be extracted in the conditions with an average extracting time and an average extracting pressure, and all that promote the extracting and tasting quality of the coffee. Besides, by the two draining through-holes, after all the extracted coffee liquid has been drained off the extracting pipe, the residual liquid in the brewing chamber can be drained off the brewing chamber smoothly to keep the next time extracted coffee liquid fresh.

### FIELD OF THE INVENTION

The present invention relates to a structure of the brewing chamber of a coffee machine, more particularly relates to an improved structure of the brewing chamber to drain off the water and the coffee, which is left inside the coffee machine, and enhance the extracting quality of the coffee.

### DESCRIPTION OF THE PRIOR ART

Generally, there are two methods to brew coffee in the coffee machine: one is used the hot water and the gravity to make coffee and drain off the coffee liquid from the filter, and this way is called filter method and this machine is called American style coffee machine. The other is used high pressure to force the hot water passing through the coffee powder to be the coffee liquid, and this way is called espresso method and this machine is called Italian style coffee machine. The espresso method can filter out some oil and fragrant ingredients, which is left in the filter method, to let the coffee taste mellower. Because of the high pressure steam being passed fast (about 20 seconds), the caffeine of the coffee bean can not be extracted in time. This is the reason that the caffeine is less than normal. The conventional coffee machine is used the espresso method to brew coffee and the operating steps of the espresso method are included: putting the ground coffee powder in the brewing chamber, extruding the coffee powder to be cube by the extruded press, draining off the high pressure hot water in the brewing chamber and drain off the coffee liquid and residue after extracting.

FIG. 1A is a cross-sectional view illustrating the internal main structure of the conventional coffee machine. And the following is the steps to operate the coffee machine. At first, the operative step of the coffee machine is to rotate the activated circle 102 to move an anti-concave wheel 106 and use the anti-concave wheel 106 to move the brewing chamber 104. And the input of the brewing machine is faced to the output of the funnel 114. This is called the brewing chamber 104 is in the first step. The ground coffee powder is falling to the filter piston 108 of the brewing chamber 104 from funnel 114. Finally, the brewing chamber 104 is full of coffee powder. The filter piston 108 is in the bottom of the brewing chamber 104 and the filter piston is stuck with the brewing chamber 104. The filter piston 108 is used to filter the coffee residue and is able to move in and out inside the brewing chamber by pushing a shaft 118, which is connected to the filter piston 108. The activated circle 102 moves the brewing chamber 104 to the second step, which is shown in FIG. 1B. The input of the brewing chamber 104 is closed by a water piston 112. In addition, a closed brewing space is formed by a water piston 112, a brewing chamber 104 and a filter piston 108. The water piston 112 is connected to a water pipe 120 and the high pressure hot water is flowing from the water piston 108 to the through-hole 1122 and then going to the brewing chamber 104. Therefore, the high pressure hot water starts to flow into the closed brewing space of the brewing chamber 104 from the water piston 112. The high pressure hot water is flowing to the coffee powder and then the coffee liquid can be extracted. And then the coffee liquid is from the filter piston 108 flowing to the cup, the extracting pipe 1042 of the brewing chamber and the drained water pipe 110. The extracting pipe 1042 can be used to stop flowing. When the water pressure of the fluid is big enough, the liquid can flow out from the drained water pipe 110. On the other hand, when there is no high pressure hot water provided from the water piston 112, the drained water pipe 110 is also stopped the liquid to flow out.

After the default value of the coffee liquid flows out, the coffee residue had become the cookie like shape and left in the filter piston 108. Referring to FIG. 1C, the water piston 112 will be pulled out from the brewing chamber 104 and the filter piston 108 can be pushed up to let the coffee residue release from the brewing chamber 104. And the brewing chamber 104 was moved by the activated circle 102 again, it was moved from the second step to the first step. After the filter piston 108 releases the coffee residue, the filter piston 108 is also moved back to the bottom of the brewing chamber 104. Therefore, the whole brewing cycle was complete.

The structure of the conventional brewing chamber of the coffee machine was described above, as shown FIG. 2. The brewing chamber 200 has a hollow room 212, which is used to dispose the coffee powder and make coffee. The two top sides of the brewing chamber 200 has two slide boards 202, which are used to let the coffee residue release from the filter piston 208 (the portion of dot line). A shaft through-hole 206 and an extracting pipe 204 are in the bottom of the brewing chamber. The shaft through-hole 206 is used to let the shaft 210 (the portion of the dot line) pass and connect to the filter piston 208. A shaft through-hole 206 and an extracting pipe 204 are in the bottom of the brewing chamber 200. The shaft through-hole 206 is used to let the shaft 210 (the portion of the dot line) pass and connect to the filter piston 208. As the description above, during the process of extracting coffee liquid, the high pressure hot water keeps flowing to the closed brewing space, and then brews the coffee powder and flows out from the extracting pipe 204. During the step of passing in and out, the speed of passing in and out is different and the coffee powder will be inflated during brewing, the pressure of the closed brewing space will be changed and the average speed of the coffee liquid will be different. Therefore, the extracting time and the pressure environment can not be stable when the coffee powder is in the brewing time and the concentration of the caffeine in the coffee is not all the same and affect the taste and quality of the coffee.

Besides, when the coffee liquid released from the extracting pipe 204, there are still some water or coffee residue left in the bottom of the brewing chamber 200. Moreover, when the filter piston 208 is in the operation of releasing residue, the side of the filter piston 208 is closely connected to the internal wall of the brewing chamber 200 and the top of the filter hole of the filter piston 208 is closed by the coffee residue. When the filter piston 208 is pushed up, the operative mode is like the movement of the vacuum pumper. Therefore, when the coffee machine is doing the next brewing, the new brewing coffee liquid is mixed with the old brewing coffee liquid, which is left in the brewing chamber 200, and affects the taste and the quality of the coffee. In addition, if the coffee residue is left in the brewing chamber 200 too long and begins to be rotten, the health of the use can be affected. Besides, when stopping to provide the high pressure hot water in the brewing operation and the moment of taking off the water piston from the brewing chamber 200, the high pressure of the closed brewing space let the coffee residue blow out from the brewing chamber 200 and the residue left within the machine affects the clean of the machine.

Because of previous description, an improved structure of brewing structure of the coffee machine is disclosed. The brewing device of the coffee machine can maintain the taste quality of the coffee and release the coffee residue and water within the brewing chamber, and avoid the coffee residue blowing off from the brewing chamber after the coffee brewing and cause the cleaning problem within the machine. The present invention provides an improve structure of the brewing chamber of the coffee machine. There are two draining through-holes added in the conventional brewing chamber and a throttle added in the extracting pipe of the brewing chamber. By adding a throttle structure, the flowing speed of the coffee liquid can be stable and average the extracting pressure and the time in the coffee powder of the brewing chamber during the brewing process. The taste quality of the coffee can be enhanced. By adding two draining through-holes, the water or the coffee residue left in the brewing chamber can be successfully released after the coffee brewing. The coffee brewing from the machine can keep fresh. In addition, the two draining through-holes can adjust the pressure to prevent the coffee residue blow off from the brewing chamber. Besides, the structure of the present invention does not need to make a big change of the conventional brewing chamber.

### SUMMARY OF THE INVENTION

The purpose of the present invention is to provide a structure of the brewing chamber of the coffee machine, which can improve the drawbacks of the conventional brewing chamber of the coffee machine.

Another purpose of the present invention is to provide a structure of the brewing chamber of the coffee machine, the structure of the conventional brewing chamber is not needed to make a big change to maintain the taste quality of the extracting coffee and the water or coffee residue left in the brewing chamber can be successfully released.

The other purpose of the present invention is to provide a structure of the brewing chamber of the coffee machine to improve the conventional brewing chamber of the coffee. After brewing coffee, there are some problems: the water of coffee residue left within the brewing chamber cannot be released and the water or coffee residue would be blew off from the brewing chamber. The present invention can solve these problems at the same time.

According the previous description, an improve structure of the brewing chamber of the coffee machine is provided in the prevent invention. There are two draining through-holes added in the conventional brewing chamber and a throttle added in the extracting pipe of the brewing chamber. The draining through-hole structure is made by a magnetic ball and a spring. And these two draining through-holes can be respectively passed through the bottom of the brewing chamber and contacted with the air. Therefore, the flowing speed of the extracting coffee liquid can be stable by the draining through-hole structure and the coffee powder of the brewing chamber can be kept in the stable status during the extracting. The taste and extracting quality of the coffee can be enhanced. Besides, when the water is left in the brewing chamber and parts of the coffee liquid is left in the filter piston during the releasing residue process, one of the two draining through-holes can be used to release those residues and the other draining through-hole can be used to contact with the outside air. The releasing way of the extracting liquid and the residual liquid in the brewing chamber of the present invention is using the physical theory of switching the cold and hot pressure in the liquid and the gas. By adding the throttle structure inside the extracting pipe, the surface and the momentum of the coffee liquid, which flows out the pipe, have a cushion effect to let the flowing speed of the extracting coffee and the hot pressure being continuous without affecting the coffee extracting quality. Two draining through-holes are added to let the residue successfully release by the pressure different and the gravity of the inside and the outside of the brewing chamber.

### BRIEF DESCRIPTION OF THE DRAWINGS

FIG. 1A illustrates a cross-sectional view of the brewing device of the conventional coffee machine.

FIG. 1B illustrates a view of the second step of the brewing device of the conventional coffee machine.

FIG. 1C illustrates a view of the movement of releasing residue in the brewing chamber of the conventional coffee machine.

FIG. 2 illustrates a cross-sectional view of the brewing chamber of the conventional coffee machine.

FIG. 3A illustrates a cross-sectional view of the brewing chamber of the coffee machine in the present invention.

FIG. 3B illustrates a vertical view of the brewing chamber in FIG. 3A.

FIG. 3C illustrates an intercepting step view within the extracting pipe of the brewing chamber in the present invention.

FIG. 3D illustrates a view of the filter piston of the brewing chamber in the present invention.

FIG. 3E illustrates a releasing movement view of the residual liquid in the brewing chamber of the present invention.

FIG. 3F illustrates a releasing movement view of he residual liquid in the brewing chamber of the present invention.

FIG. 3G illustrates a view of the brewing chamber in another embodiment of the present invention.

### DESCRIPTION OF THE PREFERRED EMBODIMENT

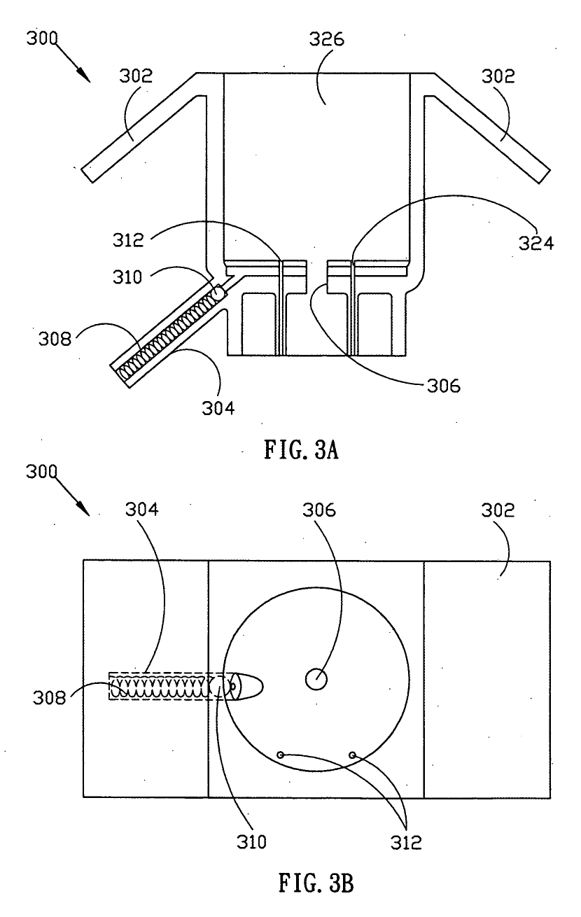

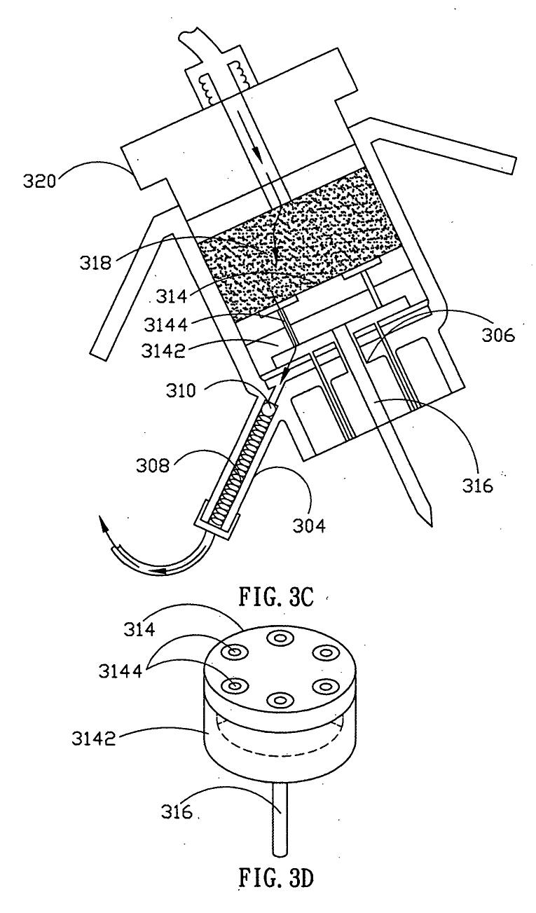

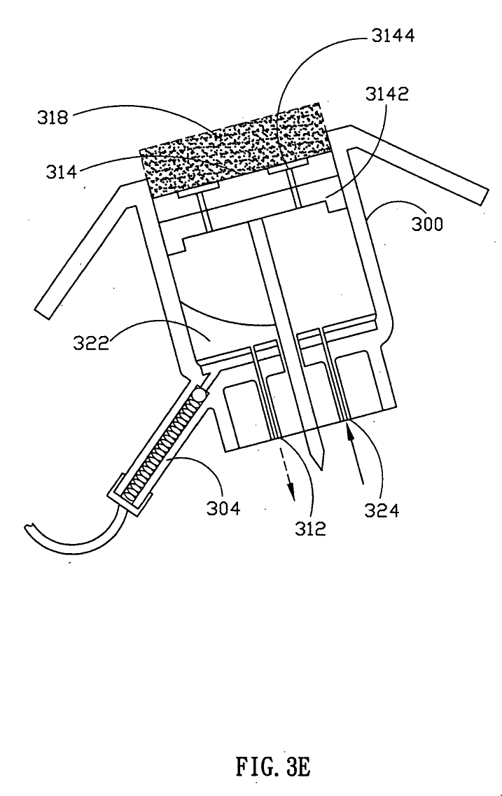

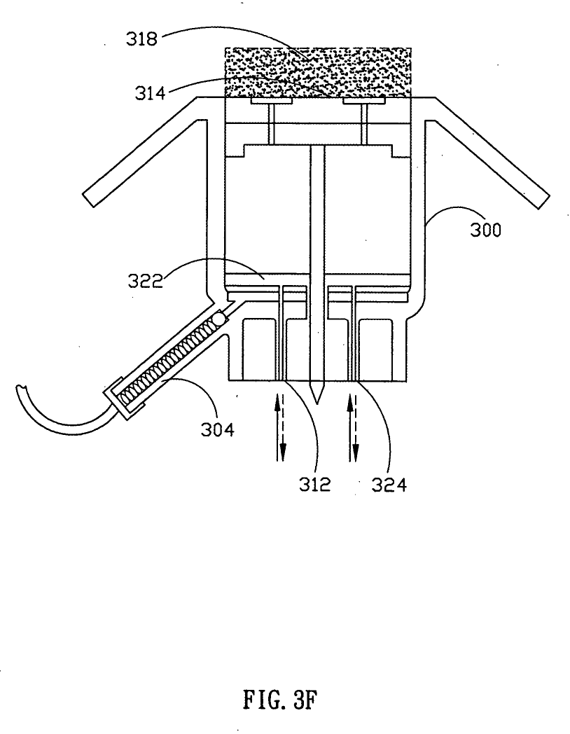

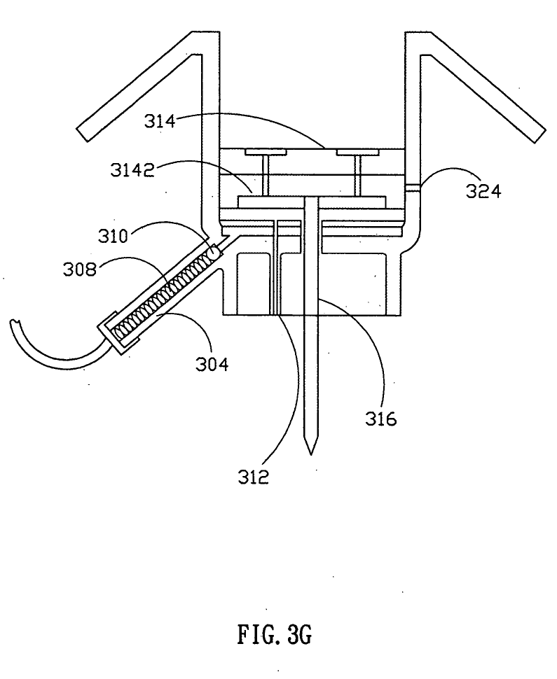

An improved structure of brewing chamber of a coffee machine is disclosed in the present invention. FIG. 3A is the cross-section view illustrating the brewing chamber in the preferred embodiment of the present invention. The brewing chamber 300 is a cylinder structure with a hollow room 316 used to provide space for coffee powder and be the brewing space. The two sides of the top of the brewing chamber 300 have two slide boards 302, which are used to let the filter piston release the coffee residue to successfully flow out by the slide board 302. The bottom of the brewing chamber 300 has an extracting pipe 304, a first draining through-hole 312, a second draining through-hole 324, and a draft through-hole 306. The extracting pipe 304 is formed in the bottom of the brewing chamber 300 and is inclined and exposed to the outside of the cylinder. And one side of the extracting pipe 304 is connected to the releasing pipe used to let the extracting coffee liquid slow out to the cup. The internal extracting pipe has a spring 308 and a magnetic ball 310, which are used to be a throttle. The magnetic ball 310 is called an intercepting piece. The one side of the spring 308 is fixed in the exit of the extracting pipe 304. The other side of the spring 308 is fixed with the magnetic ball 310. In addition, the diameter of the magnetic ball 308 is less than the bore diameter of the extracting pipe 304. In other embodiments, the intercepting piece can be replaced by some cylinders' or other shapes' materials, which are able to endure high temperature and high pressure. The first draining through-hole 312 and the second draining through-hole 324 are passed through the bottom of the brewing chamber 300 and connected to the external air. Both of them are used to successfully release the water or coffee, which are left within the brewing chamber 300. The position of these two draining through-holes is closed to the circle of brewing chamber. FIG. 3B is the vertical view of FIG. 3A, the draft through-hole 306 is passed through the center of the bottom of the cylinder. As shown in FIG. 3C, the draft through-hole 306 is used for the draft 326 of the filter piston 314 to pass through. The filter piston 314 can be used to move in and out within the brewing chamber by pushing and pulling the draft 316. In the present embodiment, the shape of the filter piston of the brewing chamber 300 is shown in FIG. 3D. The filter piston 314 comprises a plurality of filter holes 3144 and a circular rubber ring 3142. The shape design of the circular rubber ring 3142 in the bottom of the brewing chamber is used to close the opening of the top of the first draining through-hole 312 or the second draining through-hole 324, and the extracting coffee liquid can be flowed out from the filter hole 3144 to the center of the circular rubber ring 3142 and finally entered to the extracting pipe instead of flowing out to the first draining through-hole or second draining through-hole.

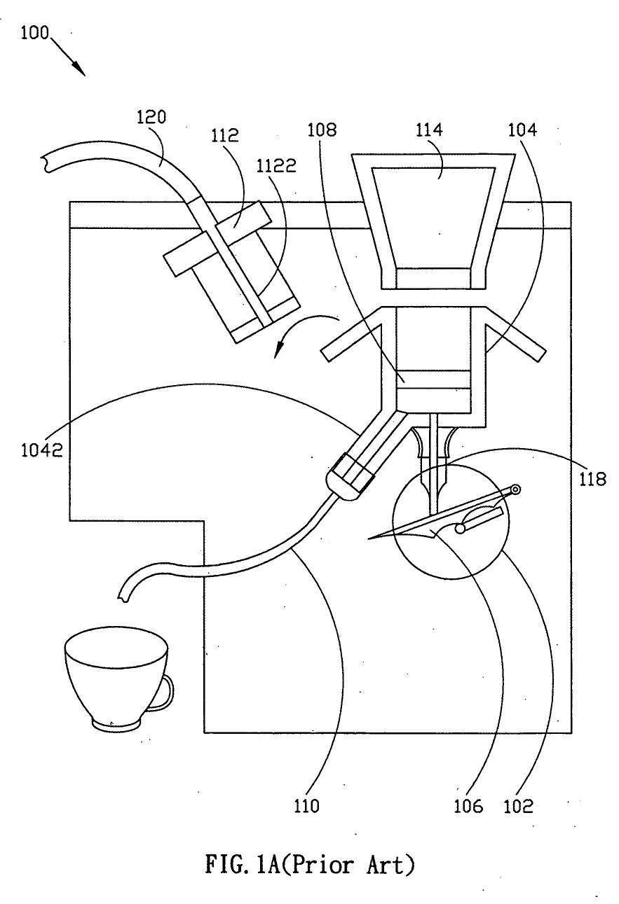

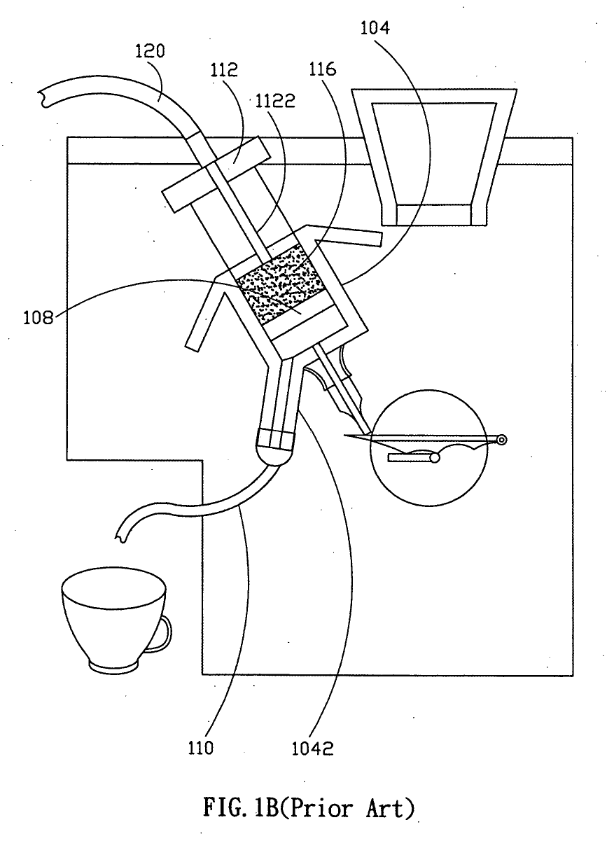

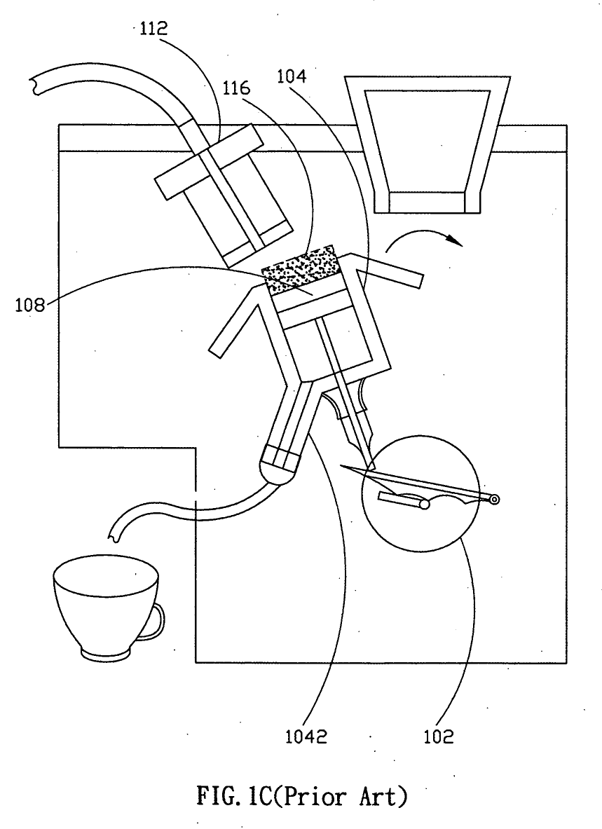

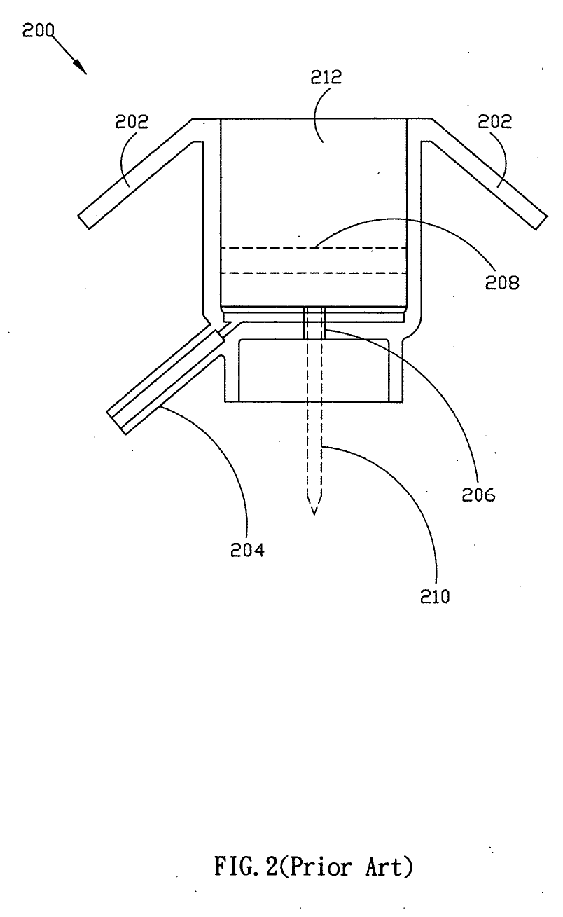

The procedure of brewing coffee in the present invention is no big different to the procedure of brewing coffee in the prior art. The following is the detail description regarding the operation of the brewing chamber in the present embodiment. Referring to FIG. 1A, when the brewing chamber 300 is in the first step, the coffee powder is entered to the brewing chamber from the funnel 114 until the brewing chamber is full of coffee powder. When the brewing chamber is in the second step of FIG. 1B, as shown in FIG. 3C, the water piston 320, the brewing chamber 300 and the filter piston 314 are formed a closed brewing space. And the closed brewing space is full of coffee powder. The high pressure hot water is from the water piston flowed into the closed brewing space and melted the coffee powder. Then, the water is entered the filter hole 3144 and flowed out from the extracting pipe 304. However, as the previous description, the high pressure hot water is kept flowing into the closed brewing space, melted the coffee powder and then flowed out from the extracting pipe. During the procedure of passing in and out, the speed of passing in and out is different and the coffee powder will be expanded during brewing, the pressure of the closed brewing space will be changed to let the average speed of the coffee liquid be different. Therefore, the extracting time and the pressure environment can not be stable when the coffee powder is in the brewing time and the concentration of the caffeine in the coffee is not all the same and affect the taste and quality of the coffee. The different of operating the brewing chamber between the present invention and the convention is when the extracting coffee liquid is entered to the extracting pipe 304 from the brewing chamber 300, the coffee liquid will collide with the magnetic ball 310 of the extracting pipe 304 and flow along with the wall of the magnetic ball 310, and the flowing surface of the coffee liquid is smaller than the surface of opening of the extracting pipe at that time. The magnetic ball 310 is pushed the spring 308 and the portion of momentum or power of the coffee liquid will be absorbed by the spring 308 and have the effect of intercepting control. And the size of the magnetic ball 310 and the spring 308 can be changed by the need and have the different results. Therefore, the average speed of the extracting coffee liquid and the coffee liquid of the extracting environment within the brewing chamber can be stable to maintain the taste and quality of the coffee.

After extracting the coffee liquid, the brewing chamber is from the position of the second step back to the position of the first step. At the moment, referring to FIG. 3E, the filter piston 314 is used to push up and do the extracting process. As the previous description, when the coffee liquid is flowed out from the extracting pipe 304, there is some water left in the brewing chamber 300. Moreover, in the movement of releasing residue of the filter piston 314, the edge of the circle rubber ring 3144 of the filter piston 314 is closely connected to the wall of the brewing chamber 300, and the filter hole 3144 of the top of the filter piston 314 is closed by the coffee residue 318. When the filter piston is pushed up, the operating mode is like the vacuum pumper to pump the portion of the coffee liquid back to the brewing chamber 300 and then the liquid 322 is left inside the brewing chamber 300. Comparing to the conventional brewing chamber, there are two draining through-holes in the bottom of the brewing chamber, the first draining through-hole and the second through-hole, and both of them are connected to the air. As shown in FIG. 3E, when the brewing chamber 300 is the position of the second step moving to the position of the first step and the liquid is left in the bottom of the brewing chamber, and the brewing chamber is in slide position and the air pressure is entered to the second draining through-hole 324 (the real arrow), which is in the higher position. The liquid within the brewing chamber 300 is flowed out from the first draining through-hole 312 (the dotted arrow), which is in the lower position. Wherein the liquid left in the brewing chamber is flowed out and put in the container disposed inside the coffee machine. When the position of the brewing chamber 300 is closely moving to vertical, as shown in FIG. 3F, there is still some liquid inside the brewing chamber. The air is entered from one of two draining through-holes and the water is flowed out from the other of two draining through-holes. In a fast and alternative way to switch, once the air is entered from the first draining through-hole and flowed out from the second draining through-hole, and the air is entered from the second draining through-hole and flowed out from the first draining through-hole. The internal of the brewing chamber 300 will have pressure changed because of air. The purpose of designing two draining through-holes is to utilize a draining through-hole to connect to the air and cause the pressure different, and let the liquid can be flowed out at the other draining through-hole. On the other hand, in other embodiments, there are more than two draining through-holes can be added in the bottom of the brewing chamber and the water releasing result can be the same. In other embodiments, the designing position of putting the draining through-holes can be changed, as shown in FIG. 3G, the first draining through-hole 312 can be put in the bottom of the brewing chamber 300 and the second draining through-hole can be put in one side of the brewing chamber 300, the water releasing result can also be the same. It should be noted that no matter where the designing position of the draining through-hole is, the opening of the draining through-hole can be closed by the circle rubber ring of the filter piston when the filter piston is in the bottom of the brewing chamber. Besides, although there is only one extracting pipe in the embodiment of the present invention, more than one extracting pipes can be added in other embodiments of the present invention.

As the previous description, a releasing method of the extracting coffee liquid and the residual liquid is provided in the present invention, the releasing method of the extracting coffee liquid and the residual liquid is to change the conventional brewing chamber structure by the physics operating theory. The method comprises: installing an intercepting device within said extracting pipe, just like installing a spring and an intercepting piece within said extracting pipe; and when said extracting liquid is flowed into said extracting pipe from said brewing chamber, said intercepting piece will be the stop for the liquid flowing out from said brewing chamber. Said extracting liquid is flowed in the interval of said intercepting device and the side wall of said extracting pipe and flowed out said extracting pipe. And the portion energy of the liquid flowed out from said brewing chamber was absorbed by said spring. Because of previous description, an improved structure of brewing structure of the coffee machine is disclosed. The brewing device of the coffee machine can maintain the taste quality of the coffee and release the coffee residue and water within the brewing chamber, and avoid the coffee residue blowing off from the brewing chamber after the coffee brewing and cause the cleaning problem within the machine. The present invention provides an improve structure of the brewing chamber of the coffee machine. There are two draining through-holes added in the conventional brewing chamber and a throttle added in the extracting pipe of the brewing chamber. By adding a throttle structure, the flowing speed of the coffee liquid can be stable and average the extracting pressure and the time in the coffee powder of the brewing chamber during the brewing process. The taste quality of the coffee can be enhanced. By adding two draining through-holes, the water or the coffee residue left in the brewing chamber can be successfully released after the coffee brewing. The coffee brewing from the machine can keep fresh. In addition, the two draining through-holes can adjust the pressure to prevent the coffee residue blow off from the brewing chamber. Besides, the structure of the present invention does not need to make a big change of the conventional brewing chamber.

Although specific embodiments have been illustrated and described, it will be appreciated by those skilled in the art that various modifications may be made without departing from the scope of the present invention, which is intended to be limited solely by the appended claims.

What is claimed is:

1. A brewing chamber of the coffee machine, comprising:
a cylinder body having a hollow room, which is used to put the coffee powder and brew the coffee;
at least one pipe in the bottom of said cylinder body, wherein one side of said at least one pipe is connected to said cylinder body and said pipe is passed through the hollow room; and
an intercepting device disposed within said pipe, wherein said intercepting device is used to let the liquid within the cylinder body to have a intercepting effect.

2. The brewing chamber of claim 1, wherein said intercepting device comprising:
a spring disposed within said pipe, wherein one side of said spring is connected to said pipe; and
an intercepting piece disposed within said pipe, wherein said intercepting piece is fixed in the other side of the spring.

3. The brewing chamber of claim 1, wherein said intercepting piece stands high temperature and high pressure and won't change the shape under the effect of the high temperature liquid in said pipe.

4. The brewing chamber of claim 3, wherein said intercepting piece is a cylinder ball and the diameter of said intercepting piece is smaller than the internal diameter of said pipe.

5. The brewing chamber of claim 4, wherein said intercepting piece is a magnetic ball.

6. A brewing chamber of the coffee machine, comprising:
a cylinder body having a hollow room, which is used to put the coffee powder and brew the coffee;
at least one pipe in the bottom of said cylinder body, wherein at least one side of said pipe is connected to said cylinder body and said pipe is passed through the hollow room; and
at least two draining through-holes disposed in said cylinder body, which is used to release the residual liquid of said hollow room, and wherein said two draining through-holes are respectively passed through said cylinder body and connected to said hollow room.

7. The brewing chamber of claim 6, further comprising:
a spring disposed within said pipe, wherein one side of said spring is fixed with said pipe; and
an intercepting piece disposed within said pipe, wherein said intercepting piece is disposed in the other side of said spring.

8. The brewing chamber of claim 6, wherein said two draining through-holes are disposed in the bottom of the cylinder body and passed through the bottom said cylinder body.

9. The brewing chamber of claim 6, wherein one of said two draining through-holes is in the bottom of said cylinder body and passed through the bottom of said cylinder body and the other one of said two draining through-holes is in one side of said cylinder body and passed through one side of said cylinder body.

10. The brewing chamber of claim 6, wherein said two draining through-holes are connected to the air.

11. The brewing device of the coffee machine, comprising
a brewing chamber having a cylinder body with a hollow room is used to put the coffee powder and brew the coffee; at least one pipe in the bottom of said cylinder body and one side of said pipe is connected to said cylinder body and said pipe is passed through the hollow room; and at least two draining through-holes disposed in said cylinder body and is used to release the residual liquid of said hollow room, and wherein said two draining through-holes are respectively passed through said cylinder body and connected to said hollow room;
a shaft passing through the shaft through-hole, wherein one side of said shaft is connected to the piston;
a piston having a plurality of filter holes, wherein said piston is disposed within said brewing chamber and is able to move in and out within said brewing chamber by pushing said shaft. When said piston is moved to the bottom of said brewing chamber, said piston can let the opening of said two draining through-hole close. And the liquid within said cylinder body can be flowed into said pipe from said plurality of filter holes.

13. The brewing device of claim 12, wherein said piston comprises a circle rubber ring. When said piston is moved to the bottom of said brewing chamber, said circle rubber ring let the opening of said two draining through-holes close. And the liquid within said cylinder body can be flowed into the center of said circle rubber ring and then to said pipe from said plurality of filter holes.

14. A method to let the extracting liquid of the brewing chamber of the coffee machine stable stably flow out, comprising:
providing a brewing chamber and wherein said brewing chamber has at least one extracting pipe, which is used to let the extracting liquid within said brewing chamber and flow out from said extracting pipe;
installing an intercepting device in the inside of said extracting pipe; and
when the extracting liquid is flowed into said extracting pipe from said brewing chamber, said intercepting device can be the stop for said extracting liquid and said extracting liquid can be flowed out from the surface of said extracting pipe.

15. The method to flow out said extracting liquid of claim 14, wherein:
Installing an intercepting device within said extracting pipe, just like installing a spring and an intercepting piece within said extracting pipe; and
when said extracting liquid is flowed into said extracting pipe from said brewing chamber, said intercepting piece will be the stop for the liquid flowing out from said brewing chamber. Said extracting liquid is flowed in the interval of said intercepting device and the side wall of said extracting pipe and flowed out said extracting pipe. And the portion energy of the liquid flowed out from said brewing chamber was absorbed by said spring.

16. A method to exclude the residual liquid with the brewing chamber of the coffee machine, comprising:
providing a brewing chamber, wherein said brewing chamber has a hollow room and at least one extracting pipe. And said brewing chamber is used to put the coffee powder and brew coffee;
disposing at least two draining through-holes in said brewing chamber and wherein said two draining through-holes are respectively passed through said brewing chamber and connected to said hollow room; and
when the extracting coffee liquid within said brewing chamber is excluded by said extracting pipe and there is some residual liquid generated within said brewing chamber. Because of the different pressure, the air in the outside of said brewing chamber can be entered said brewing chamber from one of said two draining through-holes and said residual liquid can be flowed out from the other one of said two draining through-holes.
